(19) United States
(12) Patent Application Publication
(10) Pub. No.: US 2020/0059539 A1
(43) Pub. Date: Feb. 20, 2020

(54) CLOUD-NATIVE RESERVOIR SIMULATION

(71) Applicant: Landmark Graphics Corporation, Houston, TX (US)

(72) Inventors: Qinghua Wang, Katy, TX (US); Zainub Noor, Spring, TX (US); Jianxin Lu, Bellaire, TX (US)

(21) Appl. No.: 16/542,076

(22) Filed: Aug. 15, 2019

Related U.S. Application Data
(60) Provisional application No. 62/720,082, filed on Aug. 20, 2018.

(51) Int. Cl. H04L 29/06; G01V 99/00; G06F 3/0482

(52) U.S. Cl. CPC H04L 67/38; G06F 3/0482; G01V 99/005

(57) ABSTRACT

Systems and methods for cloud-based management of reservoir simulation projects are provided. A cloud-based application server may receive from a client device over the communication network information defining a reservoir simulation project for a wellsite in a hydrocarbon producing field. The reservoir simulation project may include at least one reservoir simulation job to be performed by the cloud-based application server. The information may include one or more parameters for the reservoir simulation job. The cloud-based application server may perform the reservoir simulation job according to the one or more parameters. The cloud-based application server may provide results of the simulation job to the client device over the communication network for display within a graphical user interface (GUI) provided at the client device for a cloud-based reservoir simulation application executable by the application server.

### CROSS-REFERENCE TO RELATED APPLICATIONS

This patent application claims the benefit of and priority to U.S. Provisional Patent Application No. 62/720,082, filed Aug. 20, 2018 and entitled “CLOUD-NATIVE RESERVOIR SIMULATION,” which is hereby incorporated by reference in its entirety.

### FIELD OF THE DISCLOSURE

The present disclosure relates generally to reservoir simulation applications for wellsite operations, and more particularly, to applications for managing data and workflow activities related to reservoir simulation projects.

### BACKGROUND

Many factors may affect the development of oil and gas fields. To increase the production and profitability of an oil and gas field, reservoir simulation models may be created to allow reservoir engineers to plan and manage the fields. It is difficult to know in advance all the parameters that may affect project design, such as the permeability and porosity of the underlying formation, the properties of the hydrocarbons expected to be recovered, the final realization of the surface facilities and number of wells, and the fluid-rock data. Therefore, reservoir simulation models may be tested against historical data or have a simulation of production predicted for a well or wells in the reservoir.

### BRIEF DESCRIPTION OF THE DRAWINGS

FIG. 1 illustrates an example of a network environment for a cloud-based reservoir simulation system.

FIG. 2 is a diagram of an illustrative project dashboard for managing reservoir simulation projects within a graphical user interface (GUI) of a cloud-based reservoir simulation application.

FIG. 3 is a diagram of an illustrative project creation form for creating and adding a new reservoir simulation project to the project dashboard of FIG. 2.

FIG. 4 is a diagram of an illustrative job dashboard within the GUI of the cloud-based reservoir simulation application for managing cloud-based reservoir simulation jobs associated with a selected project from the project dashboard of FIG. 2.

FIG. 5 is a diagram of an illustrative job status window for displaying different types of charts indicating the status of a reservoir simulation job in progress or the results of a completed job.

FIG. 6 is a diagram of an illustrative job creation dialog window for creating and adding a new reservoir simulation job to a selected reservoir simulation project.

FIG. 7 is a diagram of an illustrative job submission window for submitting a new reservoir simulation job for execution by a cloud-based reservoir simulation system.

FIGS. 8A-8C are diagrams of different views of a job list within a panel of window of the job dashboard of FIG. 2 for providing various user options to manage a selected reservoir simulation job based on the job's status.

FIG. 9 is a diagram of an illustrative workflow for creating a new reservoir simulation project via the GUI of the cloud-based reservoir simulation project system.

FIG. 10 is a diagram of an illustrative workflow for managing and/or monitoring the status of various job-related operations performed for a given reservoir simulation project.

FIG. 11 is a flowchart of an illustrative process for creating and managing a cloud-based reservoir simulation project via a GUI provided at a user device.

FIG. 12 is a flowchart of an illustrative process for performing one or more reservoir simulation jobs associated with a cloud-based reservoir simulation project.

FIG. 13 is a block diagram of an illustrative computer system in which one or more embodiments may be implemented.

### DESCRIPTION OF ILLUSTRATIVE EMBODIMENTS

Embodiments of the present disclosure relate to cloud-native reservoir simulation applications for managing multiple reservoir simulation projects relating to wellsite operations. While the present disclosure is described herein with reference to illustrative embodiments for particular applications, it should be understood that embodiments are not limited thereto. Other embodiments are possible, and modifications can be made to the embodiments within the spirit and scope of the teachings herein and additional fields in which the embodiments would be of significant utility.

In the detailed description herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the relevant art to implement such feature, structure, or characteristic in connection with other embodiments whether or not explicitly described.

It would also be apparent to one of skill in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

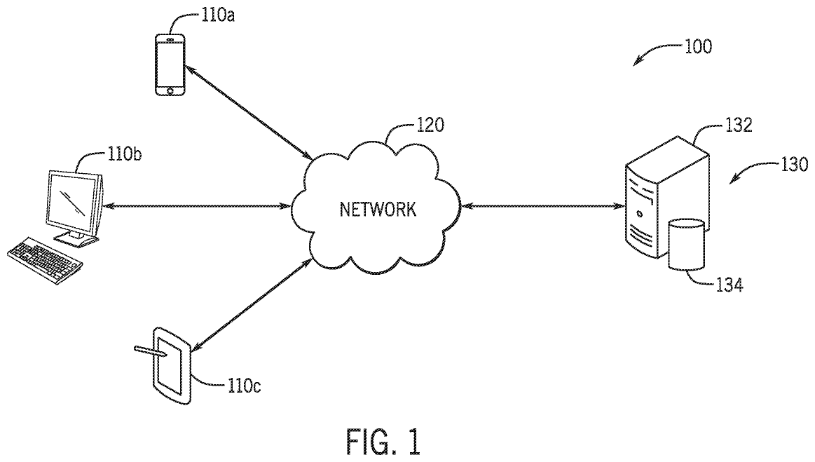

Illustrative embodiments and related methodologies of the present disclosure are described below in reference to FIGS. 1-13 as they might be employed in, for example, one or more computer systems of a cloud-based computing environment for managing reservoir simulation projects relating to hydrocarbon exploration and/or production operations at one or more wellsites within a hydrocarbon producing field. Other features and advantages of the disclosed embodiments will be or will become apparent to one of ordinary skill in the art upon examination of the following figures and detailed description. It is intended that all such additional features and advantages be included within the scope of the disclosed embodiments. Further, the illustrated figures are only exemplary and are not intended to assert or imply any limitation with regard to the environment, architecture, design, or process in which different embodiments may be implemented.

FIG. 1 illustrates an example of a network environment 100 suitable for practicing an implementation of the subject technology. As shown in FIG. 1, network environment 100, which may be referred to as a cloud-based computing infrastructure, includes one or more computing devices, such as any number of client devices 110a, 110b, and 110c (collectively referred to herein as “client devices 110a-c”), which are communicatively coupled to a remote computing system 130 via a network 120. Each of client devices 110a-c may be any type of computing device having at least one processor and a memory in the form of a computer-readable storage medium for storing data and instructions that can be read and executed by the processor. Such a computing device may also include an input interface for receiving user input or commands via a user input device (e.g., a mouse, QWERTY or T9 keyboard, touch-screen, or microphone). The computing device may also include an output interface for outputting or presenting information via a display coupled to or integrated with the device. In some implementations, the input and output interface may be combined into a single input/output (I/O) interface. Examples of such a computing device include, but are not limited to, a desktop computer (e.g., client device 110b), a laptop computer, a smartphone (e.g., client device 110a), a tablet client device 110c), a personal digital assistant (PDA), and any other fixed or mobile data processing device.

Computing system 130 may be, for example, a cloud-based computing system including one or more computing devices 132 (e.g., one or more servers, computers, or processing devices, among others) and one or more computer-readable storage devices 134. Similar to client devices 110a-c, computing device 132 can be implemented using any type of computing device having at least one processor and a memory in the form of a computer-readable storage medium for storing data and instructions that can be read and executed by the processor. In one or more embodiments, computing device 132 may be a type of server. Examples of such a server may include, but are not limited to, a web server, an application server, a proxy server, and a network server. In some implementations, computing device 132 may be a group of computing devices in a server farm or a group of disparate computing devices that are communicatively coupled together via network 120. Storage device(s) 134 may be one or more data stores or databases used to store any type of data accessible by computing device 132. In some implementations, storage device(s) 134 may be a local or remote database communicatively coupled to computing device 132. In some implementations, storage device(s) 134 may be accessible by computing device 132 over a local or wide area communication network, e.g., network 120.

In one or more embodiments, network environment 100 may represent a cloud-based computing environment implemented as, for example, a distributed client/server system in which computing device 132 is used to provide a cloud-based reservoir simulation service and related functionality (e.g., as part of a subscription as a service or SaaS) for respective users of client devices 110a-c via network 120. As will be described in further detail below, the users of client devices 110a-c may access such functionality via an interface, e.g., a graphical user interface (GUI), provided at each device. Network 120 in this example may be any type of network or combination of networks for carrying data communications. Such a network may include, for example and without limitation, a local area network, a medium area network, and/or a wide area network, such as the Internet. In some implementations, computing device 132 may communicate with client devices 110a-c and storage device(s) 134 via a private network (e.g., an “intranet”) associated with a particular company or organization.

As described above, a user at each of client device 110a-c may access and/or control various functions provided by a cloud-based or cloud-native reservoir simulation application via a client application executable at each device. Such an application may be, for example, a web browser or dedicated reservoir simulation application. The client application at each device may provide a GUI including a dashboard view with multiple control panels or windows for managing one or more reservoir simulation projects. For example, the GUI may allow a user at each device to create, view, and/or modify the details of a reservoir simulation project, including, for example, job status, computing mode, simulated production and parameters related to past and present cloud-based reservoir simulations, e.g., as performed by computing system 130.

In contrast with conventional reservoir simulation tools, the functionality provided by the cloud-based reservoir simulation application leverages a cloud infrastructure, e.g., as provided by network environment 100 of FIG. 1, to enable users to access features of the reservoir simulation application from any location and computing device with a network interface for connecting to the cloud infrastructure. The reservoir simulation application may also be available to a greater number of users or customers as part of a cloud-based subscription service or SaaS. Such cloud functionality may also improve system performance and increase computing capacity by offloading processes that would normally be performed locally at the client device to a remote computing device or server executing the reservoir simulation application in the cloud. The cloud functionality may also permit multiple simulation projects or jobs to run simultaneously instead of only one at a time, thus increasing efficiency and providing quicker simulation turnaround for the multiple projects or jobs. This functionality may also be prohibitive if relying only on the processing power of the local client device, The cloud-based simulation application may also allow control and management of multiple projects, with each project having multiple simulation jobs, that would be otherwise prohibitive if performed locally at only the client device. Artificial intelligence (or a neural network with machine learning) may be used in one or more embodiments to optimize the computing resources required for any reservoir simulation model based on the details of the model and the cost of the compute infrastructure.

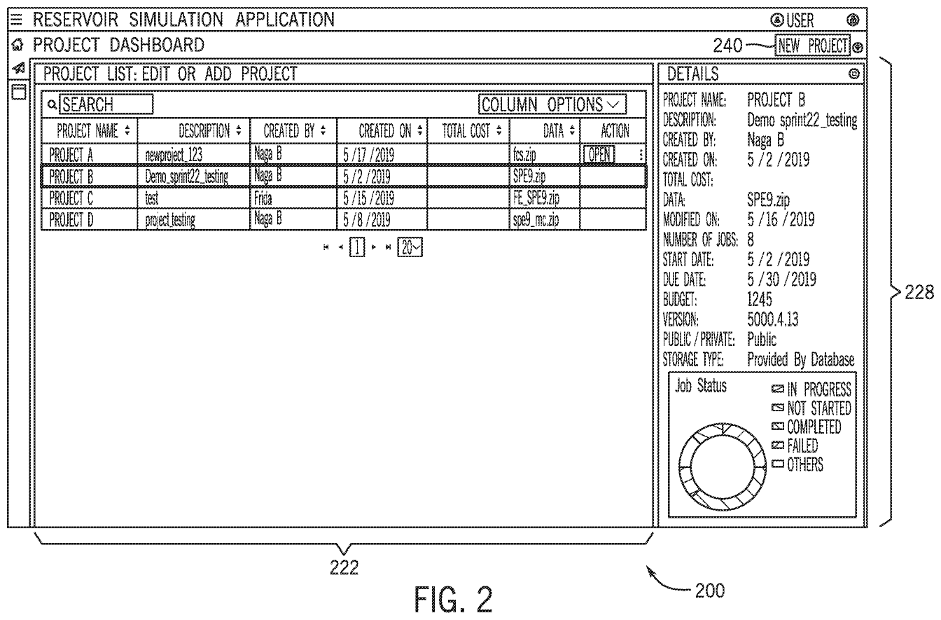

FIG. 2 is a diagram of an illustrative project dashboard 200 for managing reservoir simulation projects within a GUI of a cloud-based reservoir simulation application (e.g., associated with operations at one or more wellsites). In one or more embodiments, project dashboard 200 allows a user at a client device (e.g., any of client devices 110a-c of FIG. 1, as described above) to add and configure new cloud-based reservoir simulation projects and related tasks (or jobs) or modify existing projects. Accordingly, project dashboard 200 may be displayed within a GUI of client application that is locally executable at the user's device. The client application may communicate over a network with the cloud-based reservoir simulation application executable at a remote application server, e.g., computing device 132 of FIG. 1, as described above.

The project dashboard 200 in this example may include one or more panels or windows that allow the user to view information and control various functions of the reservoir simulation application. As will be described in further detail below, such functions may include, but are not limited to, creating new reservoir simulation projects, modifying existing projects, creating new jobs or tasks for a selected project, submitting new jobs of a project to the cloud-based reservoir simulator for execution, checking the status or progress of submitted jobs, modifying various options or simulation parameters for a selected job, and viewing the results of a simulation run executed for a job associated with a project along with relevant details related to the job and associated project.

In one or more embodiments, project dashboard 200 may include, for example and without limitation, a project list window 222 and a project details window 228. The project list window 222 may contain information on one or more projects. For example, the project list window 222 may contain any combination of the name, description, owner, creation date, last modified date, and simulation cost, among others, of each project. The information within the project list window 222 may be presented in a table, with each project listed in a single row and the different information of each project organized in respective columns. The columns may be sortable and/or searchable. In some embodiments, the project list window 222 may allow a user to manage the project data. For example, a user may add, delete, or modify the information of each project listed within the project list window 222. In some embodiments, the user may export information from or import information into the project list window 222. In some embodiments, the project data may be managed through another panel or dialog window within the project dashboard 200 or through a separate window displayed in response to user input.

The project details window 228 may contain details of a selected project and a summary of the project's parameters, such as the information displayed in the project list window 222. The project details window 228 may also contain information not displayed in the project list window 222. In some embodiments, the project details window 228 may display computer usage and/or simulation costs, such as over a desired or defined time period. For example, the project details window 228 may display the number of computer nodes allocated for the selected project and/or the simulation costs realized and/or projected for the selected project. The project details window 228 may display the information in graphical or list form.

The project dashboard 200 may include additional or alternative panels or windows providing additional or alternative functions or controls of the reservoir simulation application. For example, the project dashboard 200 may include one or more panels or dialog windows permitting a user to add or create scripts for customized workflows and/or automated workflows for one or more simulation projects.

Each window that is displayed within the project dashboard 200 may be customizable by the user, e.g., via different view configuration options provided within the project dashboard 200 for the user to select or modify using a user input device. The configuration options may include, but are not limited to, window control options for resizing and repositioning each window within the project dashboard 200 as desired by the user. For instance, each window may be maximized, minimized, closed, opened, added, or deleted within the project dashboard 200 as desired. In one or more embodiments, the windows may function as individual GUI widgets within the project dashboard 200. Accordingly, the cloud-based reservoir simulation application may include a software library (or application toolkit) containing a collection of GUI widgets that may be selectively added to or removed from the project dashboard 200 as desired by the user. The individual windows in this example may be separate floating windows that can be snapped or pinned to a designated portion of the project dashboard 200, e.g., as separate panels within the main application window, as desired by the user.

In one or more embodiments, the project dashboard 200 may include a control element in the form of a new project button 240 that the user may select via a user input device (e.g., mouse or touchpad). In response to the user's selection of the new project button 240 within the project dashboard 200, a separate window for adding or creating a new reservoir simulation project may be displayed within the GUI of the client application at the user's device, as will be described in further detail.

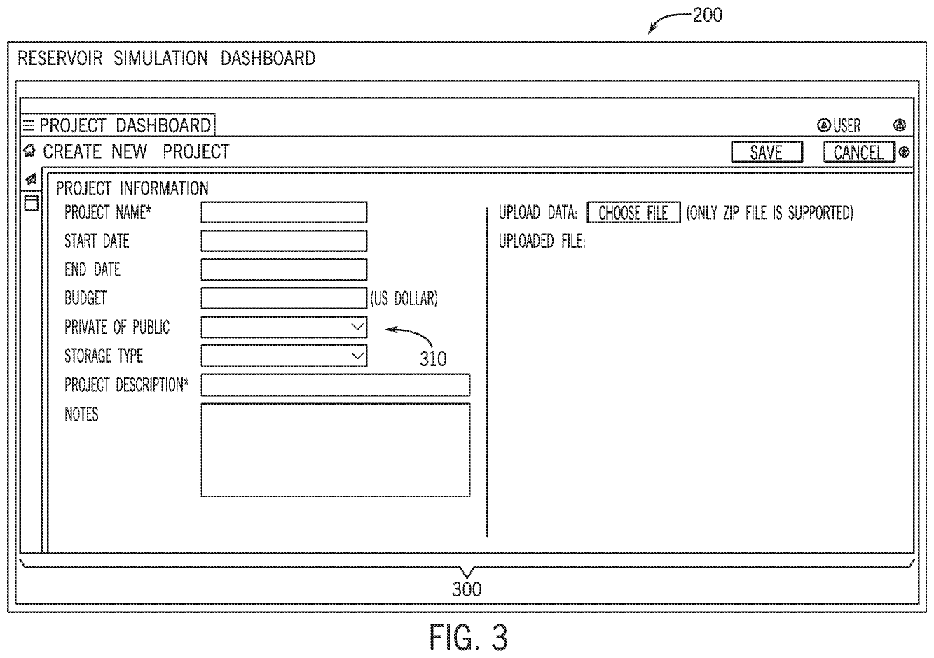

FIG. 3 is a diagram of an illustrative new project window 300 that may be displayed within the GUI of the reservoir simulation application at the user's device, e.g., in response to the user's selection of the new project button 240 within the project dashboard 200, as described above. In some implementations, the new project window 300 may be another panel displayed within the project dashboard 200 as opposed to a separate window as shown in the example of FIG. 3. For example, new project window 300 may be displayed as an additional panel within the project dashboard 200 of FIG. 2 in response to the user's selection of the new project button 240.

As shown in FIG. 3, the new project window 300 may contain one or more fields 310 for entering information related to the new reservoir simulation project. Such fields 310 may include, but are not limited to, project name, project description, project start date, project end or due date, budget, and notes. The individual fields 310 may be configured as either optional or mandatory, as desired for a particular implementation. In one or more embodiments, the information for each of fields 310 may be entered by a user via a user input device (e.g., keyboard, mouse, touchscreen, etc.) at the user's computing device, e.g., any of client device 110a-c of FIG. 1, as described above. Alternatively, such information may be included in an input file that can be uploaded to an application server in the cloud, e.g., computing device 132 via network 120 as shown in FIG. 1. In this manner, one or more parameters of a reservoir simulation project may be defined. Such parameters may be considered initial parameters of the reservoir simulation project, which may be edited by the user or through an automated process to be executed as the project or associated job progresses.

In one or more embodiments, the input data for fields 310, e.g., as entered by a user or as specified in an input file, may be used to define one or more simulation parameters of the reservoir simulation project. The input data may include, for example and without limitation, porosity, permeability, zonation, temperature, fluid saturation, rock properties, fluid properties, and field production history, among others of the reservoir in general and/or the wellsite in particular. In one or more embodiments, the simulation parameters may be included in an input file that can be uploaded to the application server in the cloud, e.g., computing device 132 via network 120 as shown in FIG. 1. The simulation parameters defined by the input data may define a simulation model, such as a baseline simulation model, for the new reservoir project.

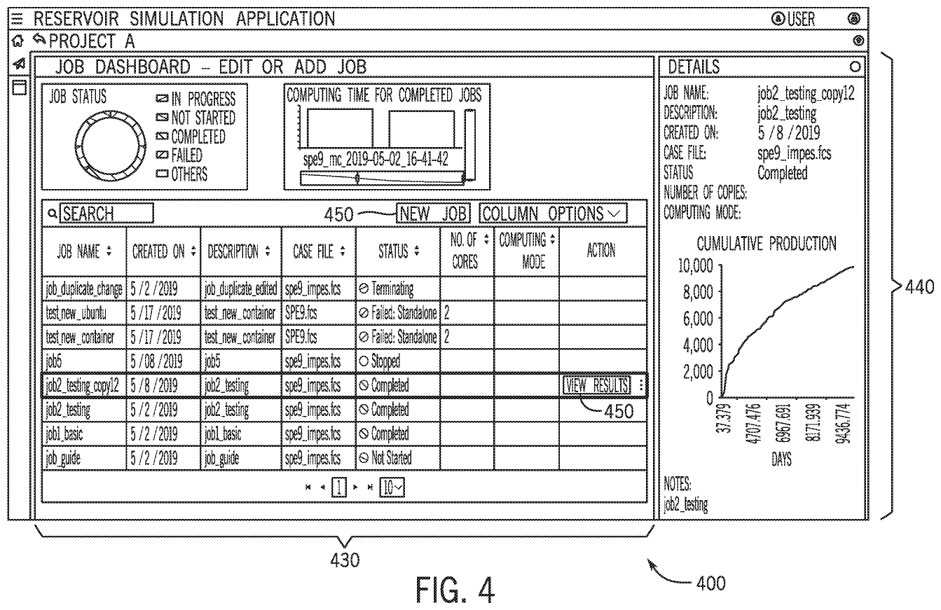

FIG. 4 is a diagram of an illustrative job dashboard 400 within the GUI of the reservoir simulation application for managing one or more cloud-based reservoir simulation jobs of a reservoir simulation project (e.g., associated with operations of a selected reservoir simulation project from the project dashboard 200 of FIG. 2). Job dashboard 400 allows a user at a client device (e.g., any of client devices 110a-c of FIG. 1, as described above) to add and configure new cloud-based reservoir simulation jobs or modify existing jobs of a particular or selected reservoir simulation project. For instance, one or more reservoir simulation jobs may be created for each reservoir simulation project, as created using new project window 300 described above.

Similar to project dashboard 200, job dashboard 400 may include one or more panels or windows that allow users to view information and control various functions of a reservoir simulation job. Such functions may include, without limitation, creating new reservoir simulation jobs, modifying existing jobs, checking the status or progress of jobs, and viewing the results of a simulation run executed for the job.

In one or more embodiments, job dashboard 400 may include, for example and without limitation, a job list window 430 and a job details window 440. The job list window 430 may contain information on one or more jobs. For example, the job list window 430 may contain any combination of the name, description, owner, creation date, last modified date, and simulation cost, among others, of each project. The information within the job list window 430 may be presented in a table, with each job listed in a single row and the different information of each job organized in respective columns. The columns may be sortable and/or searchable. In some embodiments, the job list window 430 may allow a user to manage the job data. For example, a user may add, delete, or modify the information of each job listed within the job list window 430. In some embodiments, the user may export information from or import information into the job list window 430. In some embodiments, the job data may be managed through another panel or dialog window within the job dashboard 400 or through a separate window displayed in response to user input.

The job details window 440 may contain details of a selected job and a summary of the job's parameters, such as the information displayed in the job list window 430, and its simulation results, whether graphical or list form. In some embodiments, the job details window 440 may display computer usage and/or simulation costs, such as over a desired or defined time period. For example, the job details window 440 may display the number of computer nodes allocated for the selected job and/or the simulation costs realized and/or projected for the selected job. In one or more embodiments, the job dashboard 400 may include a view results button 450 that the user may select via a user input device (e.g., mouse or touchpad) for viewing the results of the simulation, such as within a job status window displayed within the application GUI, as described below.

The job dashboard 400 may include additional or alternative panels or windows providing additional or alternative functions or controls of the reservoir simulation application. For example, the job dashboard 400 may include one or more panels or dialog windows permitting a user to add or create scripts for customized workflows and/or automated workflows for one or more simulation jobs.

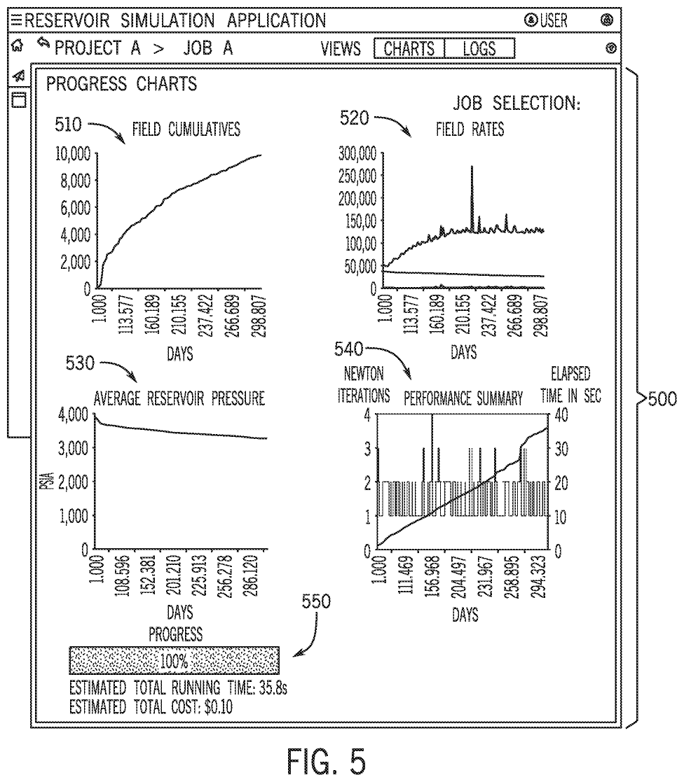

FIG. 5 is a diagram of an illustrative job status window 500 for displaying the progress of a reservoir simulation job (e.g., different types of charts indicating the status of the reservoir simulation job in progress or the results of a completed job). The job status window 500 may be another panel or dialog window within the project dashboard 200 or a separate window displayed in response to user input (e.g., after user selection of the view results button 450 of FIG. 4, described above). Simulation results of a selected simulation job or run may be displayed within the job status window 500. For instance, as shown in FIG. 5, simulated wellsite performance and/or wellsite operating parameters may be displayed graphically within the job status window 500. Illustrative results may include, without limitation, chart views of the cumulative hydrocarbon production 510, production rates 520 (oil production rate, gas production rate, water production rate, gas injection rate, water injection rate, etc.), average reservoir pressure 530, wellsite performance 540, and/or simulation progress 550, among others. In one or more embodiments, the simulated wellsite performance and/or operating parameters may be shown in a log view. In such embodiments, the user may switch between a chart view and a log view to view the simulation results as desired.

In some examples, the job status window 500 may display realized production and/or operating parameters of the wellsite recorded during wellsite operations. In such examples, the network environment 100, such as client device 110a-c, may obtain sensor data from one or more sensors monitoring wellsite operations at one or more wellsites within a hydrocarbon producing field. The measured production and/or operating parameters may then be displayed within the job status window 500. Depending on the application, the sensor data may be obtained and displayed within the job status window 500 in real time.

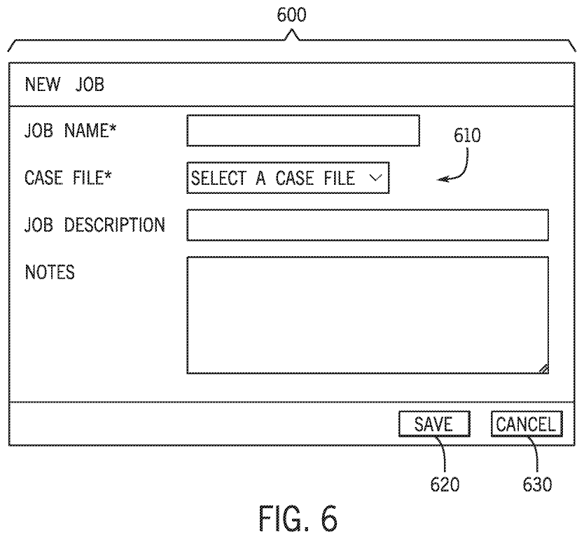

FIG. 6 is a diagram of an illustrative job creation window 600 for creating and adding a new reservoir simulation job to a selected reservoir simulation project. The job creation window 600 may be another panel or dialog window within the job dashboard 400 or a separate window displayed in response to user input. The job creation window 600 may appear within the application GUI, overlay at least a portion of the application GUI, or be a separate window displayed in response to user input and/or selection. For example, as shown in FIG. 4, the job dashboard 400 may include a new job button 450. In response to user input selecting the new job button 450 in the job dashboard 400, the job creation window 600 may be displayed in the GUI.

As shown in FIG. 6, the job creation window 600 may include one or more fields 610 related to adding or creating a new reservoir simulation job. Such fields 610 may include, but are not limited to, job name, job description, job start date, and job end date, among others. A user may enter information within each field via user input at a computing device, such as via an input device interface (keyboard, mouse, touchscreen, etc.) of client device 110a-c. Once the information is entered, the reservoir simulation job may be saved to the reservoir simulation application by selecting a save button 620. Once saved to the application, the reservoir simulation job may be displayed within the job dashboard 400 for viewing and/or modifying by a user. Prior to saving the reservoir simulation job, the job may be cancelled by selecting a cancel button 630.

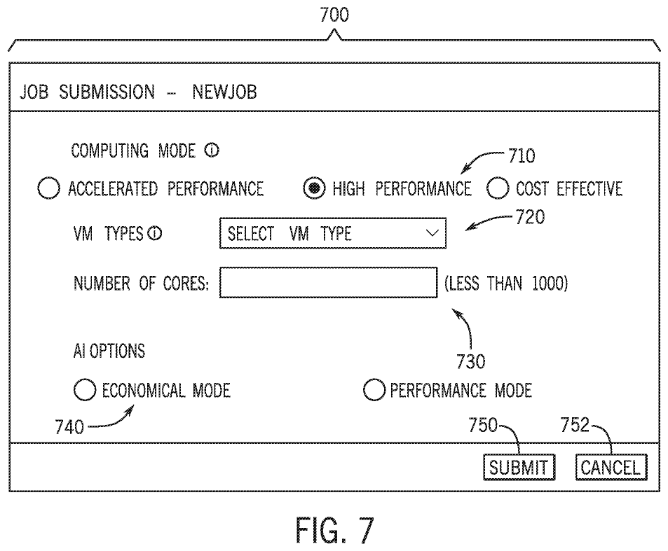

FIG. 7 is a diagram of an illustrative job submission window 700 for submitting a reservoir simulation job for execution by a cloud-based reservoir simulation system, e.g., the computing system 130 of FIG. 1, described above. The job submission window 700 may be another panel or dialog window within the job dashboard 400 or a separate window displayed in response to user input. The job submission window 700 may appear within the application GUI, overlay at least a portion of the application GUI, or be a separate window displayed in response to user input and/or selection. For example, once a reservoir simulation job is created and saved, such as via job creation window 600 of FIG. 6, as described above, the job submission window 700 may be presented as a new window dialog requiring user selection to proceed.

The job submission window 700 may define various functions and/or parameters related to a computing mode of a remote cloud-based computing system, e.g., computing system 130 of FIG. 1, as described above, for executing a new simulation job. For instance, the job submission window 700 may include various control elements allowing the user to specify one or more parameters of a desired computing mode and/or performance of computing system 130 for the simulation job. In one or more embodiments, the computing mode of the computing system 130 may be optimized based on the one or more parameters specified by the user at one of the client devices 110a-c. For example, the computing mode of the computing system 130 may be set based on user input received via the job submission window 700.

In one or more embodiments, the computing mode may be selected from a cost effective or economical mode, a high-performance mode, or an accelerated performance mode via a control element (e.g., radio button) 710 allowing the user to choose only one of the three options within the job submission window 700. The economical mode may provide an optimized computing infrastructure of the remote computing system 130 based on only a cost parameter defined by user input (budget). The accelerated performance mode, on the other hand, may provide an optimized computing infrastructure of the remote computing system 130 based on simulation performance without considering the cost parameter. The high-performance mode may be somewhere between the economical mode and the accelerated performance mode, providing an optimized computing infrastructure of the remote computing system 130 based on a balance between the cost parameter and simulation performance.

The computing mode of the computing infrastructure of the remote computing system 130 may be defined by allocating resources of the remote computing system 130 based on processing and/or virtual machine types. In some embodiments, the computing mode may be defined by allocating resources of the remote computing system 130 based on the number of processing or computing cores. in one or more embodiments, a virtual machine or processing type may be a physical computer node within the remote computing system 130 that the user connects remotely from a local computing device. In some embodiments, the virtual machine or processing type can be understood to define at least a portion of the computing infrastructure of the remote computing system 130 or can be understood to be the remote computing system 130 itself. The virtual machine or processing type may be configured to be in the same network environment, such as network environment 100 shown in FIG. 1, described above, with other cloud infrastructure components. The virtual machine or processing type may provide pre-processing, post-processing, scripting, and/or web server functionalities, among others.

In one or more embodiments, the job submission window 700 may include a drop-down menu 720 for selecting a desired virtual machine or processing type within the cloud-based reservoir simulation system that will execute the reservoir simulation job. Using the drop-down menu 720, a user may select a desired processor or processing type from amongst a list of available options. In one or more embodiments, the available options within drop-down menu 720 may be different depending on the computing mode selected via control element 710. For instance, user selection of the economical computing mode may limit the available computing cores of the remote computing system 130 to only those with budget-type processors having slower processing speeds and thus lower associated costs for the simulation. On the opposite end of the spectrum, user selection of the accelerated performance computing mode may limit the available computing cores of the remote computing system 130 to only those with premium-type processors having higher processing speeds and thus higher associated simulation costs. User selection of the high-performance computing mode may limit the available computing cores of the remote computing system 130 to those with intermediate-type processors or a mix of budget-type and premium-type processors such that the combined processing speed and simulation cost fails between those of the economical mode and the accelerated performance mode.

As shown in FIG. 7, the job submission window 700 may include one or more fields 730 allowing a user to specify the number of processing or computing cores to be allocated by the remote computing system 130 to perform the simulation job. It should be appreciated that the processing/computing cores in this example may be implemented using actual hardware, e.g., a physical processor array, or in software as virtual cores associated with a virtual machine of the type selected by the user from the menu 720. For instance, the user may specify any number of computing cores between 1 and 1000 to perform the simulation job, with lower numbers of allocated processing cores being less expensive than higher numbers of allocated computing cores at the sacrifice of simulation speed (performance). In this manner, the user may customize or tailor the simulation job based on a desired budget and performance. In a further example, the user may select the accelerated performance computing mode but allocate a lower number of computing cores within the remote computing system 130 to strike a balance between processing speed/performance and cost of the simulation job. Alternatively, the user may select the economical computing mode but allocate a higher number of computing cores within the remote computing system 130 to strike a different balance between processing speed/performance and cost of the simulation job. n this way, the user may select any one of the computing modes and any allowed number of computing cores within the remote computing system 130 to achieve a desired balance between budget and performance.

In one or more embodiments, artificial intelligence (e.g., a neural network with machine learning) may be available to optimize the computing resources for the reservoir simulation job. For example, one or more AI options may be selected via a graphical control element (e.g., radio button) 740, such as choosing between an economical AI mode or a performance AI mode. In such examples, the neural network may identify and/or calculate the virtual machine/processing type and/or number of computing cores to be allocated within the remote computing system 130 based on the selected computing mode (accelerated performance, high-performance, or economical) and AI mode (economical or performance). For instance, use of the economical AI mode may identify the virtual machine/processing type and/or calculate the number of computing cores to be allocated within the remote computing system 130 based on a cost parameter (e.g., budget). Use of the performance AI mode may identify the virtual machine/processing type and/or calculate the number of computing cores to be allocated within the remote computing system 130 based on performance of the simulation. Use of artificial intelligence may be optional with an increased cost associated with the simulation job.

Once the desired computing mode, computing options, and/or AI option is selected, the job may be submitted for simulation by selecting a submit button 750. Prior to submitting the job for simulation, the job submission may be cancelled by selecting a cancel button 752.

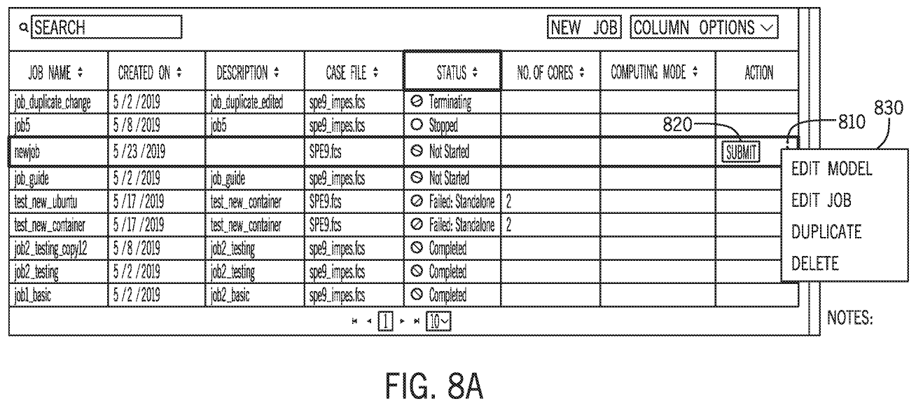

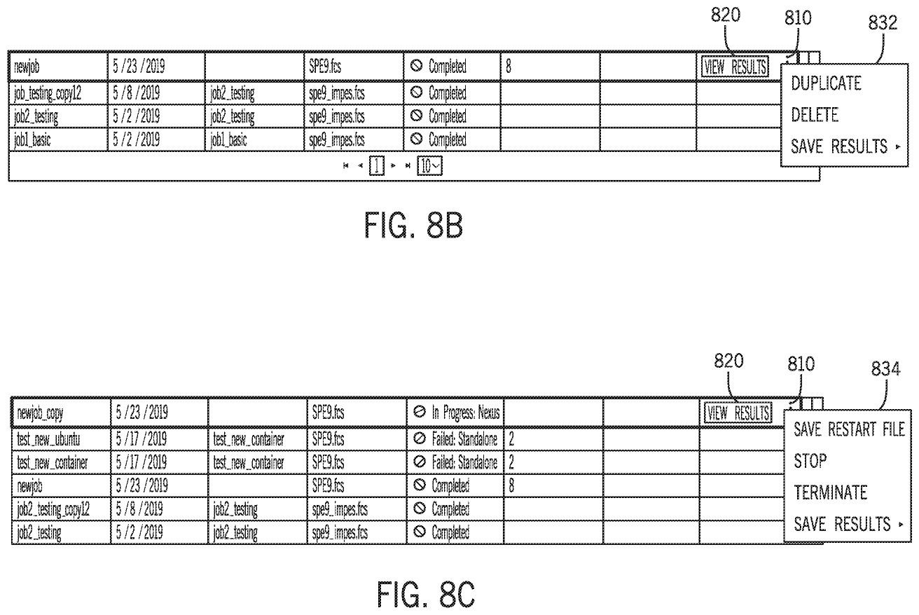

FIGS. 8A-8C are diagrams of different views of a job list within a panel or window of the job list window 430 of FIG. 4 for providing various user options to manage a selected reservoir simulation job based on the job's status. For example, each simulation job may include a status as indicated in job list window 430 of FIG. 4, described above. The status of each job may include, for example and without limitation, the following indications: not started, completed, in progress, stopped or stopping, terminated or terminating, or failed. A status of “not started” may indicate that the simulation job has been created (e.g., via job creation window 600 of FIG. 6, described above) but has not been submitted for simulation (e.g., via job submission window 700 of FIG, 7, described above). A status of “completed” may indicate that a simulation run of the job has been completed and the simulation results are ready for viewing. A status of “in progress” may indicate that the simulation run of the job has begun but has not yet completed. A status of “stopped” or “stopping” may indicate that a job that was previously in progress has been stopped or is in the progress of being stopped. Once stopped, the simulation job may resume later from its stopped position. A status of “terminated” or “terminating” may indicate that a job that was previously in progress has been terminated or is in the progress of being terminated. Once terminated, the simulation job must be restarted. A status of “failed” may indicate that the job has failed prior to or during simulation.

As shown in FIGS. 8A-8C, if a simulation job is selected, such as within job list window 430 of FIG. 4, described above, a vertical ellipsis 810 and an action button 820 associated with the selected simulation job may be displayed. As shown in FIG. 8A, if a simulation job having a status of “not started” is selected, the action button 820 may be associated with submitting the job for simulation (in which case the action button 820 may be labeled “submit”). Accordingly, user input selecting action button 820 of FIG. 8A may open job submission window 700 of FIG. 7, described above. Selecting the vertical ellipsis 810 of FIG. 8A may open first popup dialog window 830 having a first set of controls associated with a simulation job that has not been started. In one or more embodiments, the first popup dialog window 830 may include, for example and without limitation, the following controls: edit model, edit job, duplicate, and delete. Such examples are illustrative only, and the first popup dialog window 830 may include other controls and/or other control names with similar functionality, such as “clone” instead of “duplicate,” among others. User selection of “edit model” may open a dialog window allowing the user to edit the simulation model associated with the job, such as that uploaded within the new project window 300 of FIG. 3, described above. User selection of “edit job” may open a dialog window allowing the user to edit the parameters or information of the simulation job, such as those entered in the job creation window 600 of FIG. 6, described above. User selection of “duplicate” may create a copy of the selected simulation job (e.g., within the job list window 430 of FIG. 4, described above). User selection of “delete” may delete the selected simulation job from the reservoir simulation application. User selection of each control within first popup dialog window 830 may open an additional window associated with each control. For instance, user selection of “delete” may open a popup window or dialog in which deletion of the simulation job may be confirmed or cancelled.

As shown in FIG. 8B, if a simulation job having a status of “completed” is selected, the action button 820 may be associated with viewing the simulation results of the selected job (in which case the action button 820 may be labeled “view results”). Accordingly, user input selecting action button 820 of FIG. 8B may open job status window 500 of FIG. 5, described above. Selecting the vertical ellipsis 810 of FIG. 813 may open second popup dialog window 832 having a second set of controls associated with a simulation job that has not been started. In one or more embodiments, the second popup dialog window 832 may include, for example and without limitation, the following controls: duplicate, delete, and save results. Such examples are illustrative only, and the second popup dialog window 832 may include other controls and/or other control names with similar functionality, such as “clone” instead of “duplicate,” among others. User selection of “duplicate” or “delete” may open respective dialog windows providing the same functionality as those described above with reference to FIG. 8A. User selection of “save results” may open a window dialog allowing the user to save the simulation results to a desired memory storage device. In one or more embodiments, user selection of each control within second popup dialog window 832 may open an additional window associated with each control.

As shown in FIG. 8C, if a simulation job having a status of “in progress” is selected, the action button 820 may be associated with viewing the simulation results of the selected job (in which case the action button 820 may be labeled “view results”) Accordingly, user input selecting action button 820 of FIG. 8C may open job status window 500 of FIG. 5, described above. Selecting the vertical ellipsis 810 of FIG. 8C may open a third popup dialog window 834 having a third set of controls associated with a simulation job that is in progress. In one or more embodiments, the third popup dialog window 834 may include, for example and without limitation, the following controls: save restart file, stop, terminate, and save results. User selection of “save results” may open a dialog window providing the same functionality as that described above with reference to FIG. 8B. User selection of “stop” may stop the simulation job with the ability to resume simulation later if desired. User selection of “terminate” may terminate the simulation job without the ability to resume simulation, in which case the simulation run must be restarted. A user may decide to terminate, rather than stop, a simulation job if the job runs abnormally slow, hangs, or does not progress. User selection of “save restart file” may open a window dialog allowing the user to save a restart file of the simulation job to a desired memory storage device.

In one or more embodiments, user selection of each control within third popup dialog window 834 may open an additional window associated with each control. For instance, user selection of “stop” may open a popup window or dialog in which various options are presented for user selection. Such options may include, without limitation, stopping the simulation job without restarting the system, stopping the simulation job with a restart of the system, and continuing the simulation job after a restart of the system. User selection of “terminate” may open a popup window or dialog in which termination of the simulation job may be confirmed or cancelled. In one or more embodiments, if the client application determines that a simulation job runs abnormally slow, hangs, or does not progress, the client application may automatically open a popup window or dialog requesting user confirmation to terminate the simulation job.

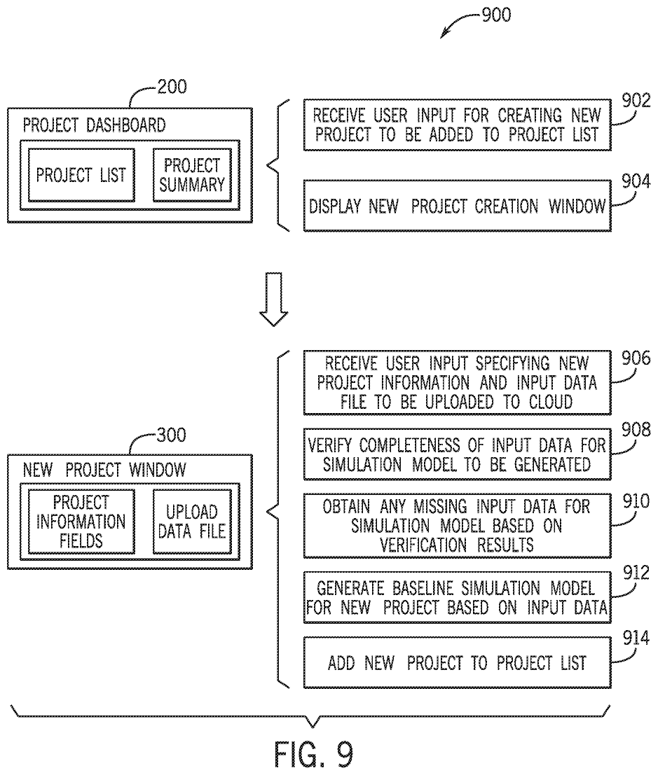

FIG. 9 is a diagram of an illustrative workflow 900 for creating a new reservoir simulation project through the reservoir simulation application at the user's device. The workflow 900 may include one or more steps associated with each window or panel displayed within the GUI of the reservoir simulation application for creating a new reservoir simulation project. Additionally, or alternatively, one or more GUI windows or panels, such as the various windows described herein, may be associated with each step of workflow 900. Each step of the workflow 900 may be associated with one or more various functions of the reservoir simulation application, such as presenting and controlling the various functions of creating a new reservoir simulation project. In addition, one or more windows or panels displayed within the reservoir simulation application may be associated with one or more steps of controlling or managing a reservoir simulation project.

As shown in FIG. 9, one or more steps of the workflow 900 may be associated with the project dashboard 200. For instance, the workflow 900 may include step 902 and step 904 associated with project dashboard 200. At step 902, the workflow 900 may include receiving user input for creating a new reservoir simulation project to be added to a project list. At step 904, the workflow 900 may include displaying a new project creation window, such as new project window 300 of FIG. 3, described above.

One or more steps of workflow 900 may be associated with the new project window 300. For example, the workflow 900 may include steps 906, 908, 910, 912, and 914 associated with new project window 300. At step 906, the workflow 900 may include receiving user input specifying new project information and an input data file to be uploaded to the cloud. For instance, the user may define a new project within new project window 300 by entering various information related to the project's name, description, schedule (start and end dates), budget, or the like, as explained above. In addition, an input file including input data associated with the project may be uploaded to the reservoir simulation application through new project window 300.

At step 908, the workflow 900 may include verifying the completeness of the input data for a simulation model to be generated. Should the input data be incomplete, the workflow 900 may proceed to step 910 in which missing input data may be obtained for the simulation results based on the verification results. For example, missing input data may be downloaded or otherwise entered into the application, such as via new project window 300. In one or more embodiments, the input data may be supplemented with historical data of the particular wellsite and/or of the hydrocarbon producing field or reservoir in general.

At panel 912, the workflow 900 may generate a baseline simulation model for the new reservoir simulation project based on the input data. Al step 914, the workflow 900 may add the new reservoir simulation project to the project list, which may be viewable via project list window 222 of FIG. 2, described above.

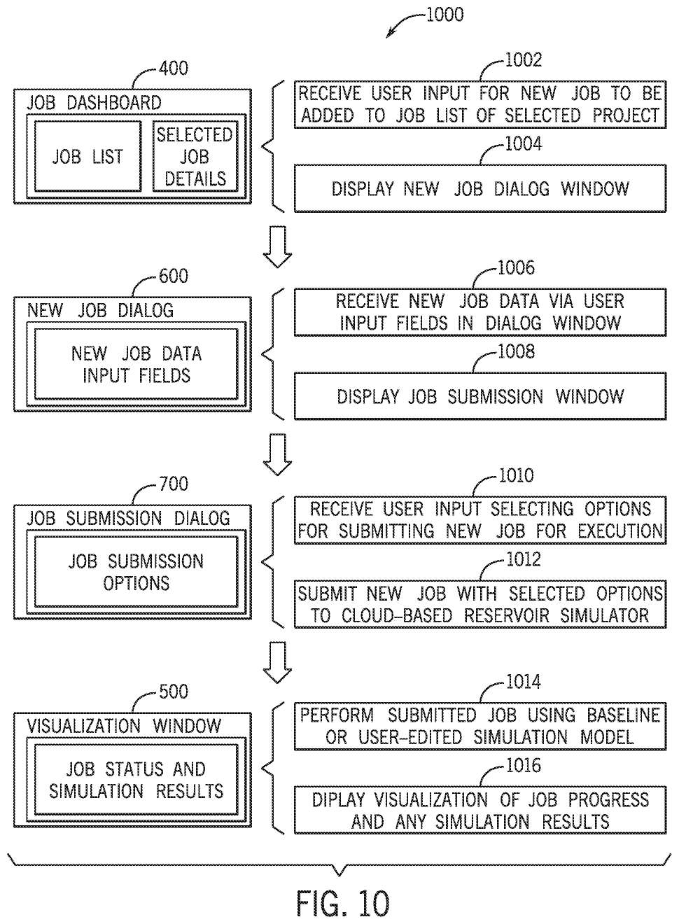

FIG. 10 is a diagram of an illustrative workflow 1000 for managing and/or monitoring the status of various job-related operations performed for a given reservoir simulation project. Like workflow 900, workflow 1000 may include one or more steps associated with each window or panel displayed within the GUI of the reservoir simulation application for managing and/or monitoring the status of various job-related operations. Additionally, or alternatively, one or more GUI windows or panels, such as the various windows described herein, may be associated with each step of workflow 1000. Each step of the workflow 1000 may be associated with one or more various functions of the reservoir simulation application, such as presenting and controlling the various functions of creating, monitoring, or editing a reservoir simulation job. In addition, one or more windows or panels displayed within the reservoir simulation application may be associated with one or more steps of controlling or managing a reservoir simulation job

As shown in FIG. 10, one or more steps of the workflow 1000 may be associated with the job dashboard 400. For instance, the workflow 1000 may include steps 1002 and 1004 associated with job dashboard 400. At step 1002, the workflow may include receiving user input for a new simulation job to be added to the job list of a selected reservoir simulation project. At step 1004, the workflow 1000 may include displaying a new job dialog window, such as job creation window 600 of FIG. 6, described above.

One or more steps of workflow 1000 may be associated with the job creation window 600. For example, the workflow 1000 may include steps 1006 and 1008 associated with the job creation window 600. At step 1006, the workflow 1000 may include receiving new job data via user input fields in a dialog window. For instance, the user may define a new job within job creation window 600 by entering various information related to the job's name, description, and schedule (start and end date), among others, as explained above. At step 1008, the workflow 1000 may include displaying a job submission window, such as job submission window 700 of FIG. 7, described above.

One or more steps of workflow 1000 may be associated with the job submission window 700. For example, the workflow 1000 may include steps 1010 and 1012 associated with job submission window 700. At step 1010, the workflow 1000 may include receiving user input selecting options for submitting a new simulation job for execution. For example, job submission window 700 may include one or more fields, graphical control elements, and/or selection prompts allowing the user to specify one or more parameters of a desired computing mode and/or performance of the job simulation. In one or more embodiments, the user may select between multiple computing modes each with a different performance characteristic, such as an accelerated performance mode, a high-performance mode, and a cost-effective mode, as described above with reference to FIG. 7. In one or more embodiments, the user may select between one or more AI options, such as those described above with reference to FIG. 7. At step 1012, the new simulation job may be submitted with the selected options to a cloud-based reservoir simulation, such as remote computing system 130 of FIG. 1, described above. In one or more implementations, after the job is submitted for simulation, the workflow 1000 may proceed to job status window 500 in which the job submission status and/or progress are di splayed.

One or more steps of workflow 1000 may be associated with the job status window 500. For example, the workflow 1000 may include steps 1014 and 1016 associated with job status window 500. At step 1014, the workflow 1000 may include performing the submitted simulation job using a baseline or user-edited simulation model. At step 1016, the workflow 1000 may include displaying a visualization of job progress and any simulation results, such as through job status window 500. For example, wellsite operation data may be collected and/or gathered during wellsite operations and displayed in job status window 500 alongside the simulation results.

FIG. 10 is illustrative only, and workflow 1000 may include additional steps. For example, in one or more embodiments, the gathered and displayed wellsite operation data may be processed and compared to the results of a simulation job, as described above. If the comparison reveals that a difference between predicted values of a downhole parameter for wellsite operations and the actual parameter values measured at the wellsite exceed a predetermined error tolerance range, workflow 1000 may include updating the simulation model to improve the accuracy of the simulation based on the difference.

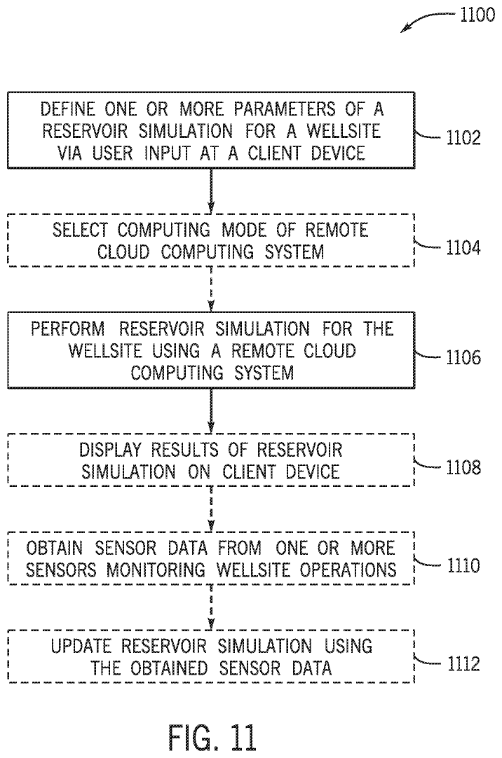

FIG. 11 is a flowchart of an illustrative process 1100 for creating and managing a cloud-based reservoir simulation project via a GUI provided at a user device. The user device may function as a client device, e.g., any of client devices 110a-c of FIG. 1, as described above, which executes a client reservoir simulation application that communicates with a cloud-based reservoir simulation application executed by remote server or computer system, e.g., remote computing system 130 of FIG. 1, as described above. The process 1100 includes defining one or more parameters of a cloud-based reservoir simulation (e.g., a reservoir simulation project or job) to be performed for a wellsite. The simulation parameters may be defined based on user input received via a GUI of the client application executable at the client device (Block 1102). As described above, the GUI of the client application may provide various user controls that allows the user to create, view, and/or modify the details of the cloud-based reservoir simulation project or job. Thus, at Block 1102, the user may manipulate the control elements of the GUI using a user input device of the client device to define one or more parameters of a new simulation project, such as through new project window 300 of FIG. 3, described above. The user may also define one or more parameters of a new simulation job, such as through job creation dialog window 600 of FIG. 6, described above. In one or more embodiments, the cloud-based reservoir simulation project or job(s) may be defined as part of a workflow for well planning and drilling operations to be performed at the wellsite. Such operations may include, but are not limited to, drilling, completion, and stimulation (e.g., hydraulic fracturing) operations for hydrocarbon exploration and recovery.

In one or more embodiments, the process 1100 may include selecting a computing mode of a remote cloud computing system, e.g., computing system 130 of FIG. 1, described above. The computing mode may be selected by through user input, such as through job submission window 700 of FIG. 7, described above. In one or more embodiments, the computing mode may be determined, such as automatically, by the client application based on the one or more parameters defined by user input. Selecting the computing mode may include defining a performance level of the remote cloud computing system. In one or more embodiments, the performance level may be selected based on a cost parameter. Additionally, or alternatively, the performance level may be selected based on a performance parameter. In one or more embodiments, the performance level may be defined by the number of computing cores utilized within the remote cloud computing system for performing the reservoir simulation. In one or more embodiments, the computing mode of the remote computing system 130 may be optimized using a neural network (AI).

In one or more embodiments, the process 1100 includes performing the reservoir simulation of the wellsite using the remote cloud computing system (Block 1106). The reservoir simulation may be performed using the one or more parameters defined at Block 1102. In one or more embodiments, the reservoir simulation may be based on the computing mode selected at

Block 1104. For instance, the reservoir simulation may be performed on the remote cloud computing system utilizing the number of computing cores selected at Block 1104. In one or more embodiments, the process 1100 may include displaying the results of the reservoir simulation on the client device (Block 1108).

In one or more embodiments, the process 1100 may include obtaining sensor data from one or more sensors monitoring wellsite operations (Block 1110). Depending on the application, the obtained sensor data may be displayed on client device. The sensor data may be obtained and displayed on client device in real time or near real time. In one or more embodiments, the process 1100 may include updating the reservoir simulation using the obtained sensor data (Block 1112). For example, the obtained sensor data may be compared with the results of the reservoir simulation. If a difference exists between the obtained sensor data and the predicted values of the reservoir simulation, such as exceeding a predetermined error tolerance range, a simulation model may he updated to improve the accuracy of the reservoir simulation based on the difference.

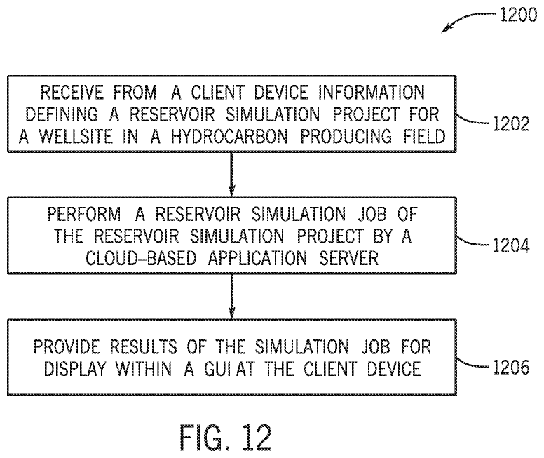

FIG. 12 is a flowchart of an illustrative process 1200 for performing one or more reservoir simulation jobs associated with a cloud-based reservoir simulation project. The process 1200 includes receiving information defining a reservoir simulation project for a wellsite in a hydrocarbon producing field (Block 1202). The information may be received by a cloud-based application server (e.g., computing system 130 of FIG. 1, described above) from a client device (e.g., any of client devices 110a-c of FIG. 1, described above) over a communication network (e.g., network 120 of FIG. 1, described above). The reservoir simulation project may include at least one reservoir simulation job to be performed by the cloud-based application server. The information may include one or more parameters for the reservoir simulation job. The one or more parameters may include at least one of a title, a start date, an end date, a budget, a computing mode, a project description, or the like. At Block 1204, the process 1200 includes performing, by the cloud-based application server, the reservoir simulation job according to the one or more parameters.

In one or more embodiments, the process 1200 may include providing results of the simulation job for display within a GUI at the client device (Block 1206). The simulation results may be provided by the cloud-based application server to the client device over the communication network.

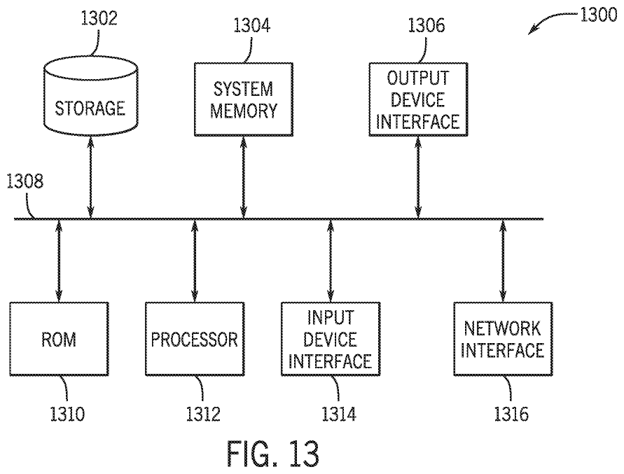

FIG. 13 is a block diagram of an illustrative computer system 1300 in which embodiments of the present disclosure may be implemented. For example, computer system 1300 may be used to implement a back-end component or cloud-based application server, e.g., computing device(s) 132 in the network environment 100 of FIG. 1, as described above, or a front-end component, e.g., each of client devices 110a-c of FIG. 1. Accordingly, the respective functions or operations performed by client devices 110a-c and computing device(s) 132 (and computing system 130) of FIG. 1, as described above, may be implemented using system 1300. Such operations may include, for example, the operations corresponding to the blocks of process 1100 and process 1200 of FIGS. 11 and 12, respectively, as described above. System 1300 can be a server, workstation, desktop or laptop computer, tablet device, smart phone, PDA, or any other type of electronic device. Such an electronic device includes various types of computer readable media and interfaces for various other types of computer readable media. As shown in FIG. 13, system 1300 includes a permanent storage device 1302, a system memory 1304, an output device interface 1306, a system communications bus 1308, a read-only memory (ROM) 1310, processing unit(s) 1312, an input device interface 1314, and a network interface 1316.

Bus 1308 collectively represents all system, peripheral, and chipset buses that communicatively connect the numerous internal devices of system 1300. For instance, bus 1308 communicatively connects processing unit(s) 1312 with ROM 1310, system memory 1304, and permanent storage device 1302.

From these various memory units, processing unit(s) 1312 retrieves instructions to execute and data to process in order to execute the processes of the subject disclosure, e.g., processes 1100 and 1200 of FIGS. 11 and 12, respectively. The processing unit(s) can be a single processor or a multi-core processor in different implementations.

ROM 1310 stores static data and instructions that are needed by processing unit(s) 1312 and other modules of system 1300. Permanent storage device 1302, on the other hand, is a read-and-write memory device. This device is a non-volatile memory unit that stores instructions and data even when system 1300 is powered off. Some implementations of the subject disclosure use a mass-storage device (such as a magnetic or optical disk and its corresponding disk drive) as permanent storage device 1302.

Other implementations use a removable storage device (such as a floppy disk, flash drive, and its corresponding disk drive) as permanent storage device 1302. Like permanent storage device 1302, system memory 1304 is a read-and-write memory device. However, unlike storage device 1302, system memory 1304 is a volatile read-and-write memory, such as a random access memory. System memory 1304 stores some of the instructions and data that the processor needs at runtime. In some implementations, the processes of the subject disclosure are stored in system memory 1304, permanent storage device 1302, and/or ROM 1310. For example, the various memory units include instructions for computer aided pipe string design based on existing string designs in accordance with some implementations. From these various memory units, processing unit(s) 1312 retrieves instructions to execute and data to process in order to execute the processes of some implementations.

Bus 1308 also connects to input and output device interfaces 1314 and 1306. Input device interface 1314 enables the user to communicate information and select commands to the system 1300. Input devices used with input device interface 1314 include, for example, alphanumeric, QWERTY, or 19 keyboards, microphones, and pointing devices (also called “cursor control devices”). Output device interfaces 1306 enables, for example, the display of images generated by the system 1300. Output devices used with output device interface 1306 include, for example, printers and display devices, such as cathode ray tubes (CRT) or liquid. crystal displays (LCD). Some implementations include devices such as a touchscreen that functions as both input and output devices. It should be appreciated that embodiments of the present disclosure may be implemented using a computer including any of various types of input and output devices for enabling interaction with a user. Such interaction may include feedback to or from the user in different forms of sensory feedback including, but not limited to, visual feedback, auditory feedback, or tactile feedback. Further, input from the user can be received in any form including, but not limited to, acoustic, speech, or tactile input. Additionally, interaction with the user may include transmitting and receiving different types of information, e.g., in the form of documents, to and from the user via the above-described interfaces.

Also, as shown in FIG, 13, bus 1308 also couples system 1300 to a public or private network (not shown) or combination of networks through a network interface 1316. Such a network may include, for example, a local area network (“LAN”), such as an Intranet, or a wide area network (“WAN”), such as the Internet. Any or all components of system 1300 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs), In some implementations, such integrated circuits execute instructions that are stored on the circuit itself. Accordingly, the functions relating to the cloud-based reservoir simulation techniques disclosed herein may be implemented using system 1300 or any computer system having processing circuitry or a computer program product including instructions stored therein, which, when executed by at least one processor, causes the processor to perform such functions.

As used in this specification and any claims of this application, the terms “computer”, “server”, “processor”, and “memory” all refer to electronic or other technological devices. These terms exclude people or groups of people. As used herein, the terms “computer readable medium” and “computer readable media” refer generally to tangible, physical, and non-transitory electronic storage mediums that store information in a form that is readable by a computer.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., a web page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Furthermore, the exemplary methodologies described herein may be implemented by a system including processing circuitry or a computer program product including instructions which, when executed by at least one processor, causes the processor to perform any of the methodology described herein.

In one embodiment of the present disclosure, a computer-implemented method for managing cloud-based reservoir simulation projects includes: receiving, by a cloud-based application server from a client device over a communication network, information defining a reservoir simulation project for a wellsite in a hydrocarbon producing field, the reservoir simulation project including at least one reservoir simulation job to be performed by the cloud-based application server, and the information including one or more parameters for the reservoir simulation job; performing, by the cloud-based application server, the reservoir simulation job according to the one or more parameters; and providing, by the cloud-based application server to the client device over the communication network, results of the simulation job for display within a graphical user interface (GUI) provided at the client device for a cloud-based reservoir simulation application executable by the cloud-based application server.

In one embodiment of the present disclosure, a system for managing cloud-based reservoir simulation projects includes at least one processor, and a memory coupled to the processor having instructions stored therein, which when executed by the processor, cause the processor to perform a plurality of functions, including functions to: receive, by a cloud-based application server from a client device over a communication network, information defining a reservoir simulation project for a wellsite in a hydrocarbon producing field, the reservoir simulation project including at least one reservoir simulation job to be performed by the cloud-based application server, and the information including one or more parameters for the reservoir simulation job; perform, by the cloud-based application server, the reservoir simulation job according to the one or more parameters; and provide, by the cloud-based application server to the client device over the communication network, results of the simulation job for display within a graphical user interface (GUI) provided at the client device for a cloud-based reservoir simulation application executable by the cloud-based application server.

In one embodiment of the present disclosure, a computer-readable storage medium having instructions stored therein, which when executed by a computer cause the computer to perform a plurality of functions, including functions to: receive, by a cloud-based. application server from a client device over a communication network, information defining a reservoir simulation project for a wellsite in a hydrocarbon producing field, the reservoir simulation project including at least one reservoir simulation job to be performed by the cloud-based application server, and the information including one or more parameters for the reservoir simulation job; perform, by the cloud-based application server, the reservoir simulation job according to the one or more parameters; and provide, by the cloud-based application server to the client device over the communication network, results of the simulation job for display within a graphical user interface (GUI) provided at the client device for a cloud-based reservoir simulation application executable by the cloud-based application server.

The foregoing embodiments may include any one or any combination of the following elements, features, steps, functions, or operations: the information defining the reservoir simulation project is based on user input received via a project dashboard displayed. within the GUI at the client device; the reservoir simulation project is a selected one of a plurality of reservoir simulation projects displayed within the project dashboard; receiving, via the GUI, user input for adding one or more reservoir simulation jobs to the reservoir simulation project; displaying within the GUI a job creation panel for defining the one or more reservoir simulation jobs to be added to the reservoir simulation project; the one or more reservoir simulation jobs are added to a job dashboard displayed within the GUI for the selected reservoir simulation project; the job dashboard listing reservoir simulation jobs associated with the reservoir simulation project and displaying status information for a selected one of the listed reservoir simulation jobs; the selected reservoir simulation job is performed by the cloud-based application server in response to a corresponding job submission request received via the job dashboard; the job submission request causes the GUI to display a job submission panel providing user controls for defining job parameters of the selected reservoir simulation job to be performed by the cloud-based application server; the job parameters include a computing mode of the cloud-based application server for performing the selected reservoir simulation job; the computing mode of the cloud-based application server is selected from the group consisting of an economical mode, a high-performance mode, and an accelerated performance mode; each computing mode of the cloud-based application server corresponds to one of a plurality of performance levels of the cloud-based application server for performing the selected reservoir simulation job; each performance level is defined by a number of computing cores utilized by the cloud-based application server for performing the selected reservoir simulation job; the user controls provided by the job submission panel include controls for optimizing a user-selected performance level of the cloud-based application server using at least one of a specified number of multiple computing cores, a virtual machine, or a neural network; displaying, within the GUI, status information for a selected one of the one or more reservoir simulation jobs; displaying, within the GUI, a job submission panel providing user controls for defining job parameters of the selected reservoir simulation job to be performed by the cloud-based application server; displaying user controls for defining the one or more parameters for the reservoir simulation job to be performed by the cloud-based application server; and the user controls include controls for optimizing a user-selected performance level of the cloud-based application server using at least one of a specified number of computing cores, a virtual machine, or a neural network.

While specific details about the above embodiments have been described, the above hardware and software descriptions are intended merely as example embodiments and are not intended to limit the structure or implementation of the disclosed embodiments. For instance, although many other internal components of the system 1300 are not shown, those of ordinary skill in the art will appreciate that such components and their interconnection are well known.

In addition, certain aspects of the disclosed embodiments, as outlined above, may be embodied in software that is executed using one or more processing units/components. Program aspects of the technology may be thought of as “products” or “articles of manufacture” typically in the form of executable code and/or associated data that is carried on or embodied in a type of machine readable medium. Tangible non-transitory “storage” type media include any or all of the memory or other storage for the computers, processors or the like, or associated modules thereof, such as various semiconductor memories, tape drives, disk drives, optical or magnetic disks, and the like, which may provide storage at any time for the software programming.

Additionally, the flowchart and block diagrams in the figures illustrate the architecture, functionality, and operation of possible implementations of systems, methods and computer program products according to various embodiments of the present disclosure. It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can he implemented by special purpose hardware-based systems that perform the specified functions or acts, or combinations of special purpose hardware and computer instructions.

The above specific example embodiments are not intended to limit the scope of the claims. The example embodiments may be modified by including, excluding, or combining one or more features or functions described in the disclosure.

As used herein, the singular forms “a”, “an” and “the” are intended to include the plural forms as well, unless the context clearly indicates otherwise. It will be further understood that the terms “comprise” and/or “comprising,” when used in this specification and/or the claims, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the embodiments in the form disclosed. Many modifications and variations will be apparent to those of ordinary skill in the art without departing from the scope and spirit of the disclosure. The illustrative embodiments described herein are provided to explain the principles of the disclosure and the practical application thereof, and to enable others of ordinary skill in the art to understand that the disclosed embodiments may be modified as desired for a particular implementation or use. The scope of the claims is intended to broadly cover the disclosed embodiments and any such modification.

What is claimed is:

1. A computer-implemented method for managing cloud-based reservoir simulation projects, the method comprising:
receiving, by a cloud-based application server from a client device over a communication network, information defining a reservoir simulation project for a wellsite in a hydrocarbon producing field, the reservoir simulation project including at least one reservoir simulation job to be performed by the cloud-based application server, and the information including one or more parameters for the reservoir simulation job;
performing, by the cloud-based application server, the reservoir simulation job according to the one or more parameters; and
providing, by the cloud-based application server to the client device over the communication network, results of the simulation job for display within a graphical user interface (GUI) provided at the client device for a cloud-based reservoir simulation application executable by the cloud-based application server.

2. The method of claim 1, wherein the information defining the reservoir simulation project is based on user input received via a project dashboard displayed within the GUI at the client device, the reservoir simulation project is a selected one of a plurality of reservoir simulation projects displayed within the project dashboard, and the method further comprises:
receiving, via the GUI, user input for adding one or more reservoir simulation jobs to the reservoir simulation project; and
displaying within the GUI a job creation panel for defining the one or more reservoir simulation jobs to be added to the reservoir simulation project.

3. The method of claim 2, wherein the one or more reservoir simulation jobs are added to a job dashboard displayed within the GUI for the selected reservoir simulation project,
the job dashboard listing reservoir simulation jobs associated with the reservoir simulation project and displaying status information for a selected one of the listed reservoir simulation jobs, and the selected reservoir simulation job is performed by the cloud-based application server in response to a corresponding job submission request received via the job dashboard.

4. The method of claim 3, wherein the job submission request causes the GUI to display a job submission panel providing user controls for defining job parameters of the selected reservoir simulation job to be performed by the cloud-based application server.

5. The method of claim 4, wherein the job parameters include a computing mode of the cloud-based application server for performing the selected reservoir simulation job.

6. The method of claim 5, wherein the computing mode of the cloud-based application server is selected from the group consisting of an economical mode, a high-performance mode, and an accelerated performance mode.

7. The method of claim 6, wherein each computing mode of the cloud-based application server corresponds to one of a plurality of performance levels of the cloud-based application server for performing the selected reservoir simulation job.

8. The method of claim 7, wherein each performance level is defined by a number of computing cores utilized by the cloud-based application server for performing the selected reservoir simulation job.

9. The method of claim 8, wherein the user controls provided by the job submission panel include controls for optimizing a user-selected performance level of the cloud-based application server using at least one of a specified number of multiple computing cores, a virtual machine, or a neural network.

10. A system for managing cloud-based reservoir simulation projects, the system comprising:
at least one processor, and a memory coupled to the processor having instructions stored therein, which when executed by the processor, cause the processor to perform a plurality of functions, including functions to:
receive, by a cloud-based application server from a client device over a communication network, information defining a reservoir simulation project for a wellsite in a hydrocarbon producing field, the reservoir simulation project including at least one reservoir simulation job to be performed by the cloud-based application server, and the information including one or more parameters for the reservoir simulation job;
perform, by the cloud-based application server, the reservoir simulation job according to the one or more parameters; and
provide, by the cloud-based application server to the client device over the communication network, results of the simulation job for display within a graphical user interface (GUI) provided at the client device for a cloud-based reservoir simulation application executable by the cloud-based application server.

11. The system of claim 10, wherein the information defining the reservoir simulation project is based on user input received via a project dashboard displayed within the GUI at the client device.

12. The system of claim 11, wherein the plurality of functions comprises functions to:
receive, via the GUI, user input for adding one or more reservoir simulation jobs to the reservoir simulation project; and
display within the GUI a job creation panel for defining the one or more reservoir simulation jobs to be added to the reservoir simulation project.

13. The system of claim 12, wherein the plurality of functions comprises a function to display, within the GUI, status information for a selected one of the one or more reservoir simulation jobs.

14. The system of claim 13, wherein the plurality of functions comprises a function to display, within the GUI, a job submission panel providing user controls for defining job parameters of the selected reservoir simulation job to be performed by the cloud-based application server.

15. A computer-readable storage medium having instructions stored therein, which when executed by a computer cause the computer to perform a plurality of functions, including functions to:
receive, by a cloud-based application server from a client device over a communication network, information defining a reservoir simulation project for a wellsite in a hydrocarbon producing field, the reservoir simulation project including at least one reservoir simulation job to be performed by the cloud-based application server, and the information including one or more parameters for the reservoir simulation job;
perform, by the cloud-based application server, the reservoir simulation job according to the one or more parameters; and
provide, by the cloud-based application server to the client device over the communication network, results of the simulation job for display within a graphical user interface (GUI) provided at the client device for a cloud-based reservoir simulation application executable by the cloud-based application server.

16. The computer-readable storage medium of claim 15, wherein the plurality of functions comprises a function to display user controls for defining the one or more parameters for the reservoir simulation job to be performed by the cloud-based application server.

17. The computer-readable storage medium of claim 16, wherein the job parameters include a computing mode of the cloud-based application server for performing the reservoir simulation job.

18. The computer-readable storage medium of claim 17, wherein the computing mode of the cloud-based application server is selected from the group consisting of an economical mode, a high-performance mode, and an accelerated performance mode, each computing mode corresponding to one of a plurality of performance levels of the cloud-based application server for performing the reservoir simulation job.

19. The computer-readable storage medium of claim 18, wherein each performance level is defined by a number of computing cores utilized by the cloud-based application server for performing the reservoir simulation job.

20. The computer-readable storage medium of claim 19, wherein the user controls include controls for optimizing a user-selected performance level of the cloud-based application server using at least one of a specified number of computing cores, a virtual machine, or a neural network.
